(19) United States
(12) Patent Application Publication
(10) Pub. No.: US 2025/0146929 A1
(43) Pub. Date: May 8, 2025

(54) Method for Calibrating an Analysis System for Lab-on-a-Chip Cartridges

(71) Applicant: Robert Bosch GmbH, Stuttgart (DE)

(72) Inventors: Ingo Ramsteiner, Ettlingen (DE); Julia Heinz, Leonberg (DE)

(21) Appl. No.: 18/838,168

(22) PCT Filed: Feb. 15, 2023
(86) PCT No.: PCT/EP2023/053686

§ 371 Date: Aug. 13, 2024

(30) Foreign Application Priority Data
Feb. 15, 2022 (DE) 10 2022 201 532.0

(51) Int. Cl. G01N 21/27; G01N 21/03; G01N 21/64

(52) U.S. Cl. CPC G01N 21/274; G01N 21/643; G01N 2021/0346; G01N 2021/6482

(57) ABSTRACT

A method for calibrating measuring channels of an analysis system for lab-on-a-chip cartridges by way of a calibration cartridge is disclosed. The method includes filling a sample chamber of the calibration cartridge with a fluorophore-free solution, measuring the background fluorescence intensity for each of the measuring channels, pumping the solution within the microfluidic circuit and back into the sample chamber, measuring the background fluorescence intensity again for each measuring channel, averaging the measured background fluorescence intensities to give an averaged background fluorescence intensity, filling the sample chamber with a dye solution having a defined concentration of at least one fluorophore, measuring the fluorescence intensity of the dye solution for each of the measuring channels, pumping the solution within the microfluidic circuit and back into the sample chamber, measuring the fluorescence intensity of the dye solution again for each of the measuring channels, averaging the measured fluorescence intensities of the dye solution to give averaged fluorescence intensities for each of the measuring channels, and calculating the calibration matrix from the averaged fluorescence intensity of the dye solution and, preferably while taking into account of a preferably averaged background fluorescence intensity for each of the measuring channels.

The present invention relates to a method for calibrating an analysis system for lab-on-a-chip cartridges by means of a calibration cartridge. The invention also relates to an analysis system with an electronic control unit which is set up to carry out the calibration.

### PRIOR ART

Microfluidic devices, such as microfluidic chips, are used for various applications. Such fluidic devices, usually made of plastic, can be used for analytical, preparative or diagnostic applications in medicine, for example. The microfluidic devices can be used, for example, in the form of a so-called lab-on-a-chip system, wherein the functionalities of a laboratory are combined to a certain extent in cheque card format. As a rule, such microfluidic devices consist of structured plastic carrier plates that integrate a channel system, various sample chambers and other functional elements, such as pumps. Such systems are particularly suitable for automated applications so that they can be used for prompt diagnostics in doctors' surgeries or hospitals, for example.

Many molecular diagnostic methods, such as quantitative real-time PCR (RT-qPCR), are based on measuring the fluorescence of a sample. The sample is irradiated with light whose wavelengths lie within the absorption band of a dye contained in the sample. The fluorescence-active dye molecules absorb the radiation and in turn emit fluorescent light, the wavelengths of which are defined by the emission band of the dye in question. Such fluorescence-active dye molecules are known as fluorophores. In typical methods, several fluorophores are used in parallel in the same sample. Light with several different wavelengths is shone onto the sample using multiplexing and read out via several different measurement channels.

The intrinsic spectral width of the absorption and fluorescence bands of typical fluorophores is so large that overlaps are unavoidable. This applies in particular if three or more fluorophores are to be combined. It is then generally no longer possible to select the excitation bands, i.e., the frequency ranges of the irradiated light, in such a way that only one dye is excited at a time. For selective measurement of a specific fluorophore, a specific excitation band is therefore combined with a specific detection band, i.e., the frequency range of the measurement channel, in order to prevent crosstalk between the measurement channels. In this way, the excitation light is spectrally narrowed to a specific excitation band and fluorescence light at wavelengths outside a defined detection band is rejected during measurement, e.g., by using suitable bandpass filters.

Despite this method, spillover effects occur in practice, in which a signal increase in one measuring channel is transferred to another measuring channel. It is known that this effect can be corrected with a linear calibration matrix. To determine the fluorescence contributions x_{DYj} caused by the dyes DYi (i specifies the dye from a total number of dyes of N) in the respective measuring channel CHj (j specifies the measuring channel from a total number of measuring channels of N—the same number of measuring channels as dyes are used), the following formula 1 can be used:

$$( \begin{matrix}{x}_{DY 1} \\ ⋮ \\ {x}_{DYN}\end{matrix} ) = ( \begin{matrix}{C}_{DY 1 , CH 1} & … & {C}_{DY 1 , CHN} \\ ⋮ & ⋱ & ⋮ \\ {C}_{DYN , CH 1} & … & {C}_{DYN , CHN}\end{matrix} ) \cdot ( \begin{matrix}{y}_{CH 1} - {b}_{CH 1} \\ ⋮ \\ {y}_{CHN} - {b}_{CHN}\end{matrix} ) \qquad ( Formula 1 )$$

The (x_{DY1} . . . x_{DYN})^{T} fluorescence contributions for the respective dyes DY1 . . . DYN, (y_{CH1} . . . y_{CHN})^{T} the fluorescence intensities measured in the respective measuring channel CH1 . . . CHN, (b_{CH1} . . . b_{CHN}) T the background frequency intensities in the respective measuring channel CH1 . . . CHN and the matrix is the calibration matrix.

The calibration matrix is obtained by measurements on a reference sample with a known concentration of fluorophores. For this purpose, a solution is first used that is as similar as possible to the reference sample, but does not contain any fluorophores itself. Now a measurement of this fluorophore-free solution is carried out with all measurement channels to obtain background fluorescence intensities. Measurements are then carried out on the reference samples with different fluorophores using all measurement channels. The measured fluorescence intensities are corrected with the background fluorescence intensities and entered into a color scatter matrix, wherein known methods of linear algebra are used to generate the matrix. The crosstalk can be seen in the secondary diagonals of the color scatter matrix. The calibration matrix is calculated as an inverse matrix of the color scatter matrix. The fluorescence contributions therefore represent (x_{DY1} . . . x_{DYN})^{T} the ratio of the fluorescence radiation to the reference sample used for calibration. A fluorescence contribution of 1 (x_{DYi}=1) therefore means that the relevant dye in the tested sample glows just as strongly as in the reference sample.

EP 1 080 364 B1 describes such a calibration method for an analysis system for lab-on-a-chip cartridges.

### DISCLOSURE OF THE INVENTION

A method for calibrating an analysis system, in particular for calibrating measurement channels of the analysis system, for lab-on-a-chip cartridges by means of a calibration cartridge is disclosed. The analysis system has means for actuating functional elements in the cartridge, such as pneumatic pumps, and measuring devices. An optical measuring device for measuring the fluorescence of the sample in the cartridge is provided here, which comprises at least one light source with which light can be irradiated in different frequency ranges onto a sample in the cartridge, and a sensor which picks up light in a predetermined frequency range. A bandpass filter can be provided to select the frequency ranges.

The calibration cartridge is designed for the respective analysis system. The calibration cartridge has at least one pre-storage chamber and at least one sample chamber as well as functional elements, such as pumps. The calibration cartridge is designed to be as similar as possible to a cartridge that is to be analyzed by the analysis system. In particular, the at least one sample chamber corresponds in design, material and position to the cartridge to be analyzed. Solutions with defined concentrations of fluorophores, which serve as calibration liquids, are provided in the at least one pre-storage chamber. The solutions each contain one of the relevant fluorophores in a precisely defined concentration, wherein the chemical composition of a relevant molecular diagnostic assay is adopted or imitated as far as possible. It is particularly advantageous that the chemical environment of the dye molecules, e.g., the coupling to oligonucleotides, the ion concentrations in the buffer solution and the like, are identical. As a result, factors that influence the position and shape of spectral absorption and emission bands of the dyes are adopted. In addition, a fluorophore-free solution is provided, i.e., a liquid that does not contain any fluorophores and can be used for background measurement and for rinsing the sample chamber. Preferably, this fluorophore-free solution is at least similar in its optical properties (apart from the spectral characteristics of the dyes themselves) to the dye solutions. For example, the buffer solution used can be provided without fluorophores.

The following steps are preferably carried out: At the beginning, a sample chamber of the calibration cartridge is filled with the fluorophore-free solution. As described above, the fluorophore-free solution is as similar as possible to the dye solutions used, without containing the dyes themselves, and can, for example, be the buffer solution used. A measurement is then carried out using the optical measuring device via the measuring channels to be calibrated and the background fluorescence intensity is measured. The measurement channels to be calibrated can preferably be all measurement channels of the analysis system or alternatively selected measurement channels that are to be calibrated. The solution is then pumped within the microfluidic circuit and then pumped back into the sample chamber. A new measurement is then carried out using the same optical measuring device via the measuring channels and the background fluorescence intensity is measured again. Optionally, the solution can now be pumped again within the microfluidic circuit and then back into the sample chamber and a new measurement can be carried out. These two steps of pumping and measuring can be repeated as often as required. The measured background fluorescence intensities are then averaged. Known methods for averaging signals can be used here. An averaged background fluorescence intensity is obtained across the measurement channels. This preferably first part of the method thus advantageously serves to determine the background fluorescence intensity for the measurement channels to be calibrated. Instead of such a determination, values for the background fluorescence intensity can in particular also be assumed and/or specified for the measurement channels. For example, the values can be set to 0, especially if the background fluorescence intensity is considered negligible. Furthermore, existing values for the background fluorescence intensity of the measurement channels to be calibrated, preferably already stored in the analysis system, can be used, for example values from a factory calibration. In a further embodiment, the analysis system can be set up to read in values for the background fluorescence intensity of the measurement channels to be calibrated, for example optically via a barcode/QR code or via (wireless) electronic transmission, for example via WLAN or RFID.

In the second part of the method, the sample chamber is filled with a dye solution with a defined concentration of at least one fluorophore. In particular, the dye solution has only one fluorophore with a precisely defined concentration. A measurement is then carried out using the optical measuring device via the measuring channels and the fluorescence intensity of the dye solution is measured. According to the invention, the dye solution is pumped within the microfluidic circuit and then pumped back into the sample chamber. A new measurement is then carried out using the same optical measuring device via the measuring channels and the fluorescence intensity is measured again. Optionally, the dye solution can now be pumped again within the microfluidic circuit and then back into the sample chamber and a new measurement can be carried out. These two steps of pumping and measuring can also be repeated here as often as required. The measured fluorescence intensities of the dye solution are then averaged. Known methods for averaging signals can be used here. An averaged fluorescence intensity of the dye solution is obtained across the measurement channels.

Finally, the calibration matrix is calculated from the averaged fluorescence intensity of the dye solution for the measurement channels, preferably taking into account the averaged background fluorescence intensity described above and/or alternatively taking into account assumed values and/or values stored in the analysis system for the background fluorescence intensity of the measurement channels to be calibrated as described above.

The solutions often contain microfluidic artifacts, such as air bubbles or suspended particles. These have an influence on the measurements carried out during calibration, so that the calibration is impaired. Pumping the solution—both the fluorophore-free solution and the dye solution—within the microfluidic system causes the microfluidic artifacts in the solution to be moved or even removed. If the solution is then pumped back into the sample chamber, the position, size and/or number of microfluidic artifacts will change so that they have a different effect when measured again. By averaging the measurements, the influence of microfluidic artifacts on the respective measurement and thus ultimately on the calibration can be reduced. This reduces errors in the calibration and improves the overall calibration. It is sufficient to pump the solutions into a neighboring chamber, for example, which is not filled at least during this time period.

The calibration matrix depends on many different influencing factors, which are partly determined by the analysis system, partly by the composition of the assay and partly by the cartridge. Typical influencing factors for the analysis system are the intensity and spectral distribution of the excitation bands, as well as the spectral sensitivity of the detection bands. These parameters are largely determined by the properties of the optical components, e.g., light sources, bandpass and/or edge filters, dichroic mirrors, lenses, gratings, prisms, etc., as well as their adjustment. These properties of the optical components and the adjustment are subject to manufacturing tolerances and ageing effects. Typical influencing factors of the assay are the position of the excitation and fluorescence spectra and the quantum efficiency of the fluorophores used. These influencing factors depend on the choice of fluorophores as well as on the chemical environment in the assay. Thus, the calibration depends on the particular assay and especially on the particular combination of dyes in it. The influencing factors of the cartridge relate to the sample volume and its geometry as well as the design of the cartridge. The material through which the light is introduced into the sample chamber of the cartridge must also be taken into account. The corrections required due to the influencing factors mentioned above cannot be broken down into independent parts. The calibration is thus advantageously performed for each combination of the analysis system (characterized by its hardware properties), the assay family (characterized by the optically relevant dye properties) and the cartridge type (characterized by material and design). In particular, the calibration can be carried out separately for each optical measuring device in the analysis system. In addition, the calibration can be repeated at predetermined time intervals to compensate for ageing effects.

Some light sources change their characteristics depending on their output. For analysis systems whose light intensity is adjustable, it is preferable to carry out the calibration at different power levels and to create separate calibration matrices in each case.

It is also known that the temperature of the solution influences the exact position of the excitation and emission bands. Temperature changes in the solution—often in excess of 50 K—are an intrinsic part of most molecular diagnostic methods. For this reason, the analysis systems typically have temperature regulation. It is advantageous to carry out the calibrations at different temperatures at which the measurements are taken in the analysis. If several temperatures are involved that differ significantly, several calibration matrices are preferably determined.

The analysis system can have several optical measuring devices, which have different optical paths and thus measure in separate sample chambers of the cartridge. The calibration matrices are preferably calculated individually. It is advantageous to use the same solutions for both sample chambers. For this purpose, the solutions are pumped into the other sample chamber in particular after each measurement in one sample chamber and the measurement is carried out there in the same way. By pumping the solution from one sample chamber into the other sample chamber, the pumping of the solution in the microfluidic circuit according to the invention is realized in an advantageous manner.

In order to be able to calculate the calibration matrix in a particularly simple way, it is preferable to use several different dye solutions, each with one fluorophore, and to carry out the measurement of the fluorescence intensity with these several dye solutions. The fluorophores differ from each other in their absorption and emission bands, wherein overlaps are possible. Each fluorophore is assigned a measuring channel depending on its emission band. In detail, the steps of filling, measuring, pumping, measuring again and averaging are repeated for each of the several dye solutions. The number of different dye solutions used, and thus the number of repetitions of the steps, corresponds to the number of measuring channels of the analysis system. This results in the same number of determined averaged fluorescence intensities for the respective dye solution and measuring channels of the analysis system. For each dye solution, the background fluorescence intensities can be subtracted separately from the averaged fluorescence intensities for each measurement channel. Using known methods of linear algebra, a color scatter matrix can be determined for the multiple dye solutions and the multiple measurement channels. As the number of dye solutions and measuring channels is the same, the matrix is square. The calibration matrix is calculated by forming the inverse matrix of the color scatter matrix.

When filling the sample chamber with a new dye solution, the solution previously in the sample chamber—i.e., either the fluorophore-free solution or, as described above, another dye solution—can either be displaced by the new dye solution or pressed out of the sample chamber by an actuator, whereupon the new dye solution is introduced into the sample chamber.

Preferably, before the sample chamber is filled with the new dye solution, the sample chamber is rinsed with the fluorophore-free solution. Meanwhile, the fluorescence intensity is measured. The rinsing process is preferably carried out until the measured fluorescence intensity differs from or corresponds to the background fluorescence intensity by less than a threshold value. This ensures that a dye solution previously present in the sample chamber has been removed to such an extent that it no longer has any influence on the measurements of the new dye solution during calibration. If only the fluorophore-free solution is previously in the sample chamber, the rinsing process is omitted.

The filling of the sample chamber with the new dye solution is preferably repeated several times. Optionally, a measurement can be carried out in the measuring channel assigned to the new dye solution. The filling of the sample chamber is preferably repeated until the measured fluorescence intensity of the dye solution no longer increases. In this case, the maximum concentration of the fluorophore in the sample chamber has been reached.

It may be necessary to carry out a function test for the determined calibration matrix. Two types of function tests are described below:

In the first type, an analysis of the same dye solution(s) is performed, in which the method steps of filling, measuring, pumping, measuring again and averaging with the newly calculated calibration matrix are carried out again. In addition, the previously mentioned measures, i.e., rinsing and/or filling until the maximum concentration is reached, can also be carried out. The averaged background fluorescence intensities measured at the beginning are subtracted from the averaged fluorescence intensities of the dye solution(s) measured with the new calibration matrix. The system checks whether this value exceeds a threshold value only for the assigned measuring channel. If this is the case, the function test is considered passed and the new calibration matrix is used. For the above-mentioned case with several dye solutions, each of which has a fluorophore assigned to a measuring channel, it is checked whether only the combination of the dye solution with the fluorophore and the corresponding measuring channel exceeds the fluorescence intensity threshold value. Otherwise, the new calibration matrix is discarded and an error message is displayed.

In the second type of functional test, a reference sample with a mixture of fluorophores with defined proportions is stored in a pre-storage chamber upstream of the calibration cartridge. The method steps of filling, measuring, pumping, measuring again and averaging are carried out again with the reference sample instead of the dye solution and with the newly calculated calibration matrix. In addition, the previously mentioned measures, i.e., rinsing and/or filling until the maximum concentration is reached, can also be carried out. The averaged background fluorescence intensities measured at the beginning are subtracted from the averaged fluorescence intensities of the reference solution measured with the new calibration matrix. These values are then used to calculate the fluorescence contributions of the fluorophores in the reference sample using the new calibration matrix according to formula 1, which correspond to the proportions of fluorophores in the reference sample. It is checked whether the calculated proportions of fluorophores in the reference sample deviate from the actual, defined proportions of fluorophores in the reference sample by no more than a threshold value. If this is the case, the function test is considered passed and the new calibration matrix is used. Otherwise, the new calibration matrix is discarded and an error message is displayed. In the second type of functional test, the averaged fluorescence intensities of the reference sample are only determined once for analysis. Repeated measurements with different dye solutions are not necessary.

Furthermore, an analysis system for lab-on-a-chip cartridges is proposed which has an electronic control unit which is set up to calibrate the analysis system using the method described above.

### BRIEF DESCRIPTION OF THE DRAWINGS

Exemplary embodiments of the invention are shown in the drawings and explained in more detail in the following description.

FIG. 1 shows a schematic representation of two sample chambers of a calibration cartridge.

FIG. 2 shows a flowchart of an exemplary embodiment of the method according to the invention.

FIG. 3 shows the test chambers from FIG. 1 during various steps of the method according to the invention.

### EXEMPLARY EMBODIMENTS OF THE INVENTION

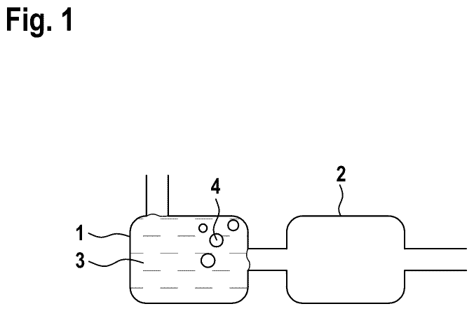

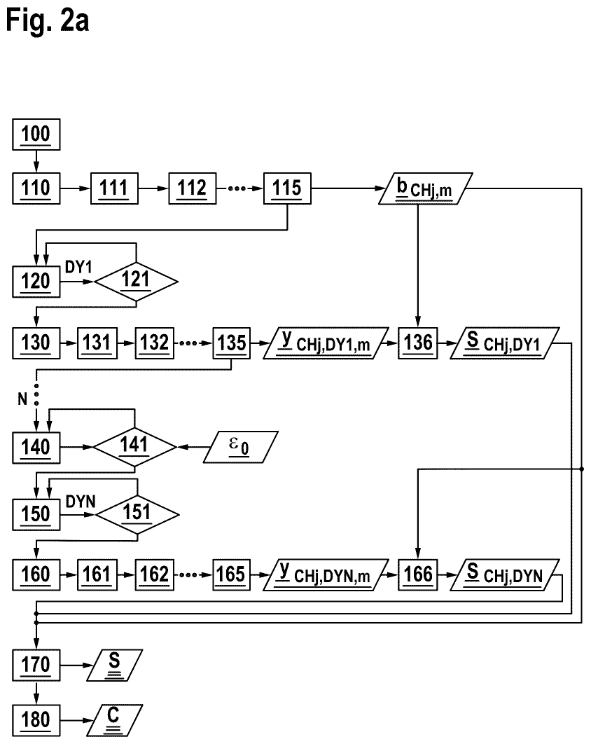

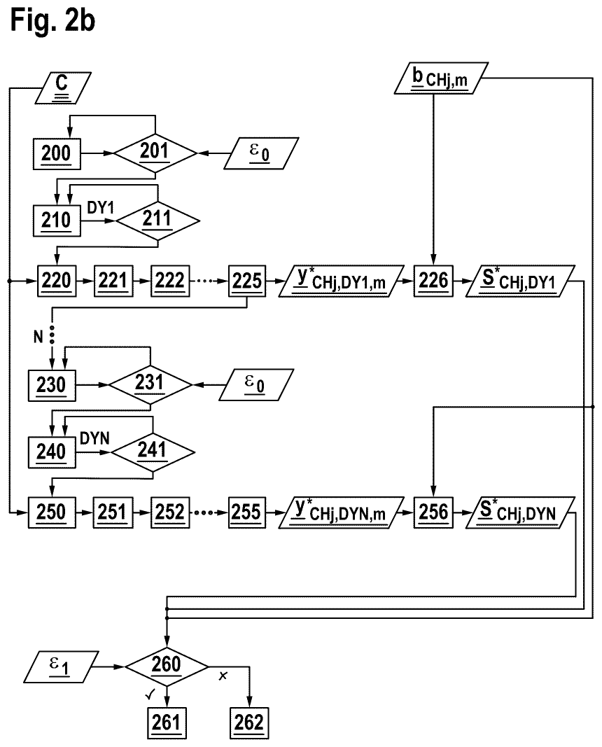

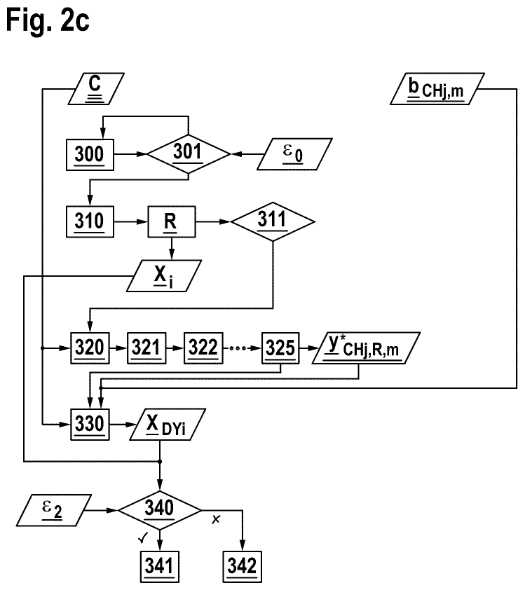

FIG. 1 shows two test chambers 1, 2 of a calibration cartridge that is not otherwise shown. The calibration cartridge is used with the method according to the invention described below to calibrate an analysis system, such as a Vivalytic system, which is also not shown. The calibration cartridge is similar in design to a conventional microfluidic cartridge for the analysis system and holds calibration liquids 3 in pre-storage chambers not shown. The calibration liquids 3 are on the one hand dye solutions DYi, each of which contains a fluorophore in a defined concentration, and on the other hand a fluorophore-free solution that does not contain a fluorophore—for example, a buffer solution that is used with the aforementioned dye solutions. In addition, when the method according to FIG. 2c is carried out, the calibration cartridge can hold a reference sample R with a mixture of several fluorophores with defined proportions as calibration liquid 3 in a pre-storage chamber. Each sample chamber 1, 2 is examined for fluorescence by a separate optical measuring device of the analysis system. The optical measuring devices have several measuring channels that measure in different frequency ranges. The number N of measuring channels corresponds to the number N of fluorophores to be analyzed and thus also to the number N of different dye solutions used. Each measuring channel is assigned to a fluorophore. In FIG. 1, the first sample chamber 1 is filled with one of the above-mentioned calibration liquids 3. In the microfluidic cartridges, microfluidic artifacts can occur in the liquids, including in the calibration cartridge, as shown in FIG. 1 in the form of air bubbles 4 in the calibration liquid 3 or as suspended particles or similar. These microfluidic artifacts can distort the result of the calibration.

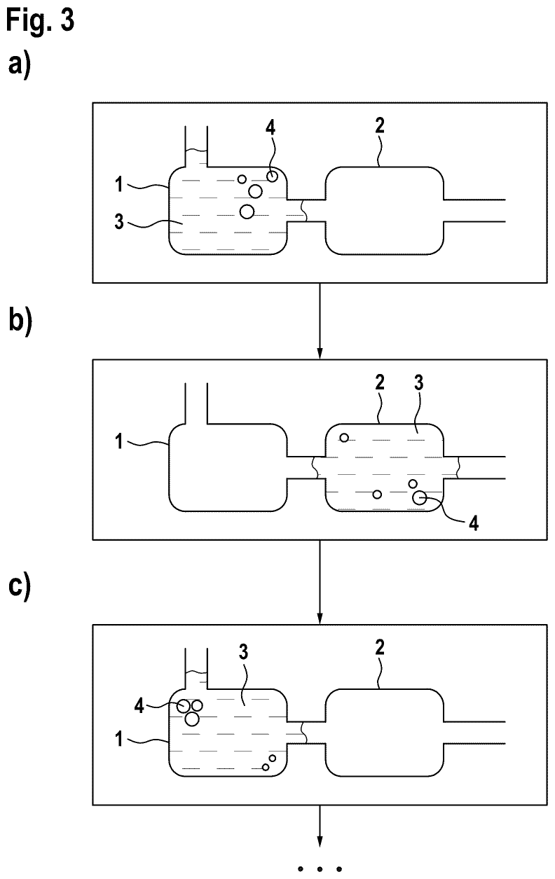

FIG. 2 shows a flow chart of an embodiment of the method according to the invention, in which all measuring channels are calibrated as an example. Alternatively, only selected measuring channels can be calibrated accordingly. FIG. 2a shows the calculation of a calibration matrix C and FIGS. 2b and 2c each show a functional test for the calculated calibration matrix C. At the beginning, the first sample chamber 1 is filled 100 with the fluorophore-free solution. A first measurement 110 of the fluorescence intensity of the fluorophore-free solution is then carried out for all measurement channels CHj and the background fluorescence intensity is measured. The fluorophore-free solution is then pumped 111 into the second sample chamber 2 and then back into the first sample chamber 1. Please refer to FIG. 3 and the associated description. A second measurement 112 of the fluorescence intensity of the fluorophore-free solution is then carried out for all measurement channels CHj and the background fluorescence intensity is also measured. The steps pump 111 and measure 112 can be repeated as often as required. Finally, the measured background fluorescence intensities are averaged 115 and an averaged background fluorescence intensity b_{Chj,m} is obtained for all measurement channels CHj.

The sample chamber 1 is now filled 120 with the first dye solution DY1, which has a first fluorophore in a defined concentration. Either the fluorophore-free solution is displaced by the dye solution or the fluorophore-free solution is first squeezed out and then the dye solution DY1 is added. Filling 120 is carried out until a measured fluorescence intensity in the measuring channel CH1 belonging to the dye solution no longer increases 121. A maximum concentration of the fluorophore is then given in the first sample chamber 1. A first measurement 130 of the fluorescence intensity for this first dye solution DY1 is then carried out for all measurement channels CHj. The first dye solution DY1 is then pumped 131 into the second sample chamber 2 and then back into the first sample chamber 1. Reference is also made to FIG. 3 and the associated description. A second measurement 132 of the fluorescence intensity of the first dye solution DY1 is then carried out for all measurement channels CHj. The steps pump 131 and measure 132 can be repeated as often as required. Finally, the measured fluorescence intensities for the first dye solution DY1 are averaged 135 and an averaged fluorescence intensity y_{CHj,DY1,m} is obtained for the first dye solution DY1 for all measurement channels CHj. The averaged background fluorescence intensity b_{Chj,m} for all measuring channels CHj is subtracted 136 from this averaged fluorescence intensity y_{CHj,DY1,m} for the first dye solution DY1 for all measuring channels CHj and the result is stored as the entry S_{CHj,DY1}.

The steps 140 through 166 described below are repeated for each dye solution DYi. For reasons of brevity and clarity, this is only described below for the DYN dye solution.

The old dye solution is rinsed out 140 of the first sample chamber 1. The fluorophore-free solution, for example the buffer solution, is used for this purpose. The rinsing 140 is carried out until a measured fluorescence intensity for one or more measurement channels CH1 . . . CHN differs 141 by less than a threshold value ε₀ from the averaged background fluorescence intensity b_{Chj,m} for the measurement channel(s). The sample chamber 1 is now filled 150 with an nth dye solution DYN, analogous to that described above, until a measured fluorescence intensity in the measuring channel CHN belonging to the dye solution no longer increases 151. A first measurement 160 of the fluorescence intensity for this nth dye solution DYN is then carried out for all measurement channels CHj. The nth dye solution DYN is then pumped 161 into the second sample chamber 2 and then back into the first sample chamber 1. Reference is also made to FIG. 3 and the associated description. A second measurement 162 of the fluorescence intensity of the nth dye solution DYN is then carried out for all measurement channels CHj. The steps pump 161 and measure 162 can be repeated as often as required. Finally, the measured fluorescence intensities for the nth dye solution DYN are averaged 135 and an averaged fluorescence intensity y_{CHj,DYN,m} for the nth dye solution DYN is obtained for all the measurement channels CHj. The averaged background fluorescence intensity b_{Chj,m} for all measuring channels CHj is subtracted 166 from this averaged fluorescence intensity y_{CHj,DYN,m} for the nth dye solution DYN for all measuring channels CHj and the result is stored as the entry S_{CHj,DYN}.

From the entries S_{CHj,DY1} . . . S_{CHj,DYN} for all dye solutions DYi and all measurement channels CHj (in the measurements 130, 132, 160, 162, measurements were always taken over all measurement channels CHj), a color scatter matrix S with the following form is calculated 170 using known methods of linear algebra:

$${S}_{=} = ( \begin{matrix}{S}_{CH 1 , DY 1} & … & {S}_{CH 1 , DYN} \\ ⋮ & ⋱ & ⋮ \\ {S}_{CHN , DY 1} & … & {S}_{CHN , CYN}\end{matrix} )$$

The color scatter matrix S is inverted 180 to obtain the calibration matrix C with the following form:

$${C}_{=} = ( \begin{matrix}{C}_{DY 1 , CH 1} & … & {C}_{DY 1 , CHN} \\ ⋮ & ⋱ & ⋮ \\ {C}_{DYN , CH 1} & … & {C}_{DYN , CHN}\end{matrix} )$$

FIG. 2b shows a first function test for the calibration matrix C. The first sample chamber 1 is rinsed with the fluorophore-free solution 200 until a measured fluorescence intensity for one or more measuring channels CH1 . . . CHN differs 201 by less than a threshold value co from the background fluorescence intensity b_{Chj,m} determined in FIG. 2a for the measuring channel or channels.

The sample chamber 1 is now filled with the above-mentioned first dye solution DY1, as described above, 210 until a measured fluorescence intensity in the measuring channel CH1 belonging to the dye solution no longer increases 211. A first measurement 220 of the fluorescence intensity for this first dye solution DY1 is then carried out for all measurement channels CHj with the newly calculated calibration matrix C. The first dye solution DY1 is then pumped 221 into the second sample chamber 2 and then back into the first sample chamber 1. Reference is also made to FIG. 3 and the associated description. A second measurement 222 of the fluorescence intensity of the first dye solution DY1 is then carried out for all measurement channels CHj with the newly calculated calibration matrix C. The steps of pumping 221 and measuring 222 can be repeated as often as desired, preferably just as often as pumping 131 and measuring 132 in FIG. 2 a. Finally, the measured fluorescence intensities for the first dye solution DY1 are averaged 225 and an averaged fluorescence intensity y*_{CHj,DY1,m} is obtained for the first dye solution DY1 for all measurement channels CHj for the newly calculated calibration matrix C. From this averaged fluorescence intensity y_{CHj,DY1,m} for the first dye solution DY1 for all measurement channels CHj for the newly calculated calibration matrix C, the averaged background fluorescence intensity b_{Chj,m}, which was determined at the beginning in FIG. 2a, is subtracted 226 for all measurement channels CHj and the result is stored as entry S*_{CHj,DY1}.

Analogous to FIG. 2a, the steps 230 through 256 described below are repeated for each dye solution DYi and are described below only for the dye solution DYN.

The old dye solution is rinsed out 230 of the first sample chamber 1 using the fluorophore-free solution until a measured fluorescence intensity for one or more measuring channels CH1 . . . CHN differs by less than a threshold value to from the averaged background fluorescence intensity b_{Chj,m} for the measuring channel(s). The sample chamber 1 is now filled 240 with an nth dye solution DYN, analogous to that described above, until a measured fluorescence intensity in the measuring channel CHN belonging to the dye solution no longer increases 241. A first measurement 250 of the fluorescence intensity for this nth dye solution DYN is then carried out for all measurement channels CHj with the new calibration matrix C. The nth dye solution DYN is then pumped 251 into the second sample chamber 2 and then back into the first sample chamber 1. Reference is also made to FIG. 3 and the associated description. A second measurement 252 of the fluorescence intensity of the nth dye solution DYN is then carried out for all measurement channels CHj with the newly calculated calibration matrix C. The steps of pumping 251 and measuring 252 can be repeated as often as desired, preferably just as often as pumping 161 and measuring 162 in FIG. 2a. Finally, the measured fluorescence intensities for the n-th dye solution DYN are averaged 255 and an averaged fluorescence intensity y*_{CHj,DYN,m} is obtained for the n-th dye solution DYN for all measurement channels CHj for the newly calculated calibration matrix C. From this averaged fluorescence intensity y*_{CHj,DYN,m} for the n-th dye solution DYN for all measurement channels CHj for the newly calculated calibration matrix C, the averaged background fluorescence intensity b_{Chj,m} for all measurement channels CHj is subtracted 256 and the result is saved as the entry S*CHj, DYN.

The system now checks whether, for the entries S*_{CHj,DYi}, only the elements S*_{CH1,DY1} . . . S*_{CHN,DYN}, which represent a corresponding combination of the dye solution DYi and the assigned measuring channel CHj, exceed a threshold value of ε₁ and the other elements do not exceed the threshold value of ε₁. The threshold value ε₁ can also be zero. In other words, it is checked whether in a color scatter matrix from the newly measured entries—although this does not have to be calculated here—only the elements of the main diagonals are greater than the threshold value ε₁ (ideally greater than 0) and the elements of the secondary diagonals are less than or equal to the threshold value ε₁ (ideally equal to 0). In the former case, the function test is passed 261 and the newly calculated calibration matrix C is used. In the latter case, the calibration matrix C is discarded 262 and an error message is issued.

FIG. 2c shows a second function test for the calibration matrix C. The first sample chamber 1 is rinsed 300 with the fluorophore-free solution until a measured fluorescence intensity for one or more measuring channels CH1 . . . CHN differs by less than a threshold value ε₀ from the averaged background fluorescence intensity bchim in FIG. 2a for the measuring channel(s) 301.

The sample chamber is now filled 310 with a reference sample 310, which is a solution containing a mixture of fluorophores with defined proportions xᵢ. Either the fluorophore-free solution is displaced by the reference sample R or the fluorophore-free solution is first squeezed out and then the reference sample R is added. The filling 310 is carried out until a measured fluorescence intensity in a measuring channel assigned to a fluorophore in the reference sample R does not increase 311. A maximum concentration of the fluorophore is then given in the first sample chamber 1. Several measuring channels can also be used simultaneously to test several fluorophores of the reference sample. A first measurement 320 of the fluorescence intensity for the reference sample R is then carried out for all measurement channels CHj with the newly calculated calibration matrix C. The reference sample R is then pumped 321 into the second sample chamber 2 and then back into the first sample chamber 1. Reference is also made to FIG. 3 and the associated description. A second measurement 322 of the fluorescence intensity of the reference sample R is then carried out for all measurement channels CHj with the newly calculated calibration matrix C. The steps of pumping 321 and measuring 322 can be repeated as often as desired, preferably just as often as pumping 131 and measuring 132 and/or pumping 161 and measuring 162 in FIG. 2 a. Finally, the measured fluorescence intensities for reference sample R are averaged 135 and an averaged fluorescence intensity y*_{CHj,R,m} is obtained for the reference sample R for all measurement channels CHj for the newly calculated calibration matrix C.

From the averaged fluorescence intensity y*_{CHj,R,m} for the reference sample R for all measurement channels CHj for the newly calculated calibration matrix C, the background fluorescence intensity b_{CHj,m} determined in FIG. 2 a and the newly calculated calibration matrix C, the fluorescence contributions x_{DYi} of the fluorophores in the reference sample R are calculated 330 according to Formula 1. The fluorescence contributions x_{DYi} are directly dependent on the proportions xᵢ of the fluorophores in the reference sample R and can therefore be interpreted as calculated proportions of fluorophores in the reference sample R. It is checked 340 whether the calculated proportions of the fluorophores corresponding to the fluorescence contributions x_{DYi} and the actual proportions xᵢ of the fluorophores differ by no more than a threshold value ε₂. The threshold value ε₂ can be a constant or can also be set to zero so that the calculated proportions of fluorophores correspond to the actual proportions xᵢ of fluorophores. Alternatively, the threshold value ε₂ can also be a percentage deviation from the absolute value of the fractions xᵢ of the fluorophores or a percentage deviation from the absolute value of the fluorescence contributions x_{DYi} or be selected as a function of the fluorescence contributions x_{DYi} and/or the fractions xᵢ of the fluorophores. In the former case, the function test is passed 261 and the newly calculated calibration matrix C is used. In the latter case, the calibration matrix C is discarded 262 and an error message is issued.

In FIG. 3, pumping 111, 131, 161; 221, 251 or 321 according to the method in FIG. 2 is explained in more detail using the sample chambers 1, 2 of the calibration cartridge in FIG. 1. At the beginning, in FIG. 3a, the calibration liquid 3, i.e., either the fluorophore-free solution or one of the dye solutions DYi or, if pumping 321 is carried out, the reference sample R, is in the first sample chamber 1. From there, the calibration liquid 3 is pumped into the second sample chamber 2, as shown in FIG. 3b. Pumping causes the air bubbles 4 to move within the calibration liquid 3. After the calibration liquid 3 in FIG. 3c has been pumped back into the first sample chamber 1, the air bubbles 4 are now in a different position in the sample chamber 1. Now the calibration liquid 3 can be pumped back into the second sample chamber 2 after measurement 130, 132, 160, 162; 220, 222, 250, 252; 320, 322. This can be repeated as often as required. As a result, they have a different influence on the measurement than at the point in FIG. 3a. Averaging 115, 135, 165; 225, 255; 325 will reduce the influence of air bubbles and other microfluidic artifacts.

The two test chambers 1 and 2 are examined by different optical measuring devices. The calibration method according to the invention is carried out for both optical measuring devices. Pumping the calibration liquid 3 into the second sample chamber 2 is simultaneously filling the second sample chamber 2 with the same calibration liquid 3 as the first chamber. The inventive method can now be carried out for the second sample chamber. The measurements 130, 132, 160, 162; 220, 222, 250, 252; 320, 322 in the sample chambers 1, 2 are thus carried out alternately during pumping 111, 131, 161; 221, 251; 321.

1. A method for calibrating measuring channels of an analysis system for lab-on-a-chip cartridges by way of a calibration cartridge, comprising:
vi) filling the sample chamber with a dye solution with a defined concentration of at least one fluorophore;
vii) measuring the fluorescence intensity of the dye solution for each of the measurement channels;
viii) pumping the solution within the microfluidic circuit and back into the sample chamber;
ix) re-measuring the fluorescence intensity of the dye solution for each of the measurement channels;
x) averaging the measured fluorescence intensities of the dye solution to averaged fluorescence intensities for each of the measurement channels; and
xi) calculating the calibration matrix from the averaged fluorescence intensity of the dye solution taking into account an averaged background fluorescence intensity, for each of the measurement channels.

2. The method according to claim 1, wherein the method comprises the following steps prior to step vi):
i) filling a sample chamber of the calibration cartridge with a fluorophore-free solution;
ii) measuring the background fluorescence intensity for each of the measurement channels;
iii) pumping the solution within the microfluidic circuit and back into the sample chamber;
iv) re-measuring the background fluorescence intensity for each of the measurement channels; and
v) averaging the measured background fluorescence intensities to an averaged background fluorescence intensity for each of the measurement channels.

3. The method according to claim 1, wherein the calibration matrices are calculated individually for different optical measuring devices of the analysis system which examine separate sample chambers, and wherein the same solutions are used.

4. The method according to claim 1, wherein steps vi) through x) are repeated for several different dye solutions each with one fluorophore, and wherein the number of the different dye solutions corresponds to the number of measuring channels of the analysis system.

5. The method according to claim 4, wherein after each repetition before step vi), the sample chamber is rinsed with a fluorophore-free solution until a measured fluorescence intensity differs from the background fluorescence intensity by less than a threshold value.

6. The method according to claim 1, wherein step vi) is repeated until the measured fluorescence intensity of the dye solution no longer increases.

7. The method according to claim 1, wherein, for a functional test, steps vi) through x) are carried out again with the newly calculated calibration matrix and, if the averaged fluorescence intensities of the dye solution, measured with the aid of the newly calculated calibration matrix, minus the averaged background fluorescence intensities exceeds a threshold value only for the respectively assigned measurement channel, the function test is deemed to have been passed and the new calibration matrix is used, and otherwise the new calibration matrix is rejected and an error message is output.

8. The method according to claim 1, wherein for a functional test a reference sample with a mixture of fluorophores with defined proportions is pre-stored in a pre-storage chamber, steps vi) through x) are carried out again with the reference sample instead of the dye solution and with the newly calculated calibration matrix, the proportions of the fluorophores in the reference sample are calculated from the averaged fluorescence intensities, measured with the aid of the newly calculated calibration matrix, minus the measured averaged background fluorescence intensities and, if the calculated proportions of the fluorophores in the reference sample deviate from the actual proportions of the fluorophores in the reference sample by no more than a threshold value, the functional test is deemed to have been passed and the new calibration matrix is used, and otherwise the new calibration matrix is rejected and an error message is output.

9. An analysis system for lab-on-a-chip cartridges with comprising an electronic control unit which is set up to carry out a calibration by means way of a method according to claim 1.
